(19) United States
(12) Patent Application Publication
(10) Pub. No.: US 2017/0166005 A1
(43) Pub. Date: Jun. 15, 2017

(54) WHEEL RIM AND METHOD OF MANUFACTURING THE SAME

(71) Applicant: GIANT MANUFACTURING CO., LTD., TAICHUNG CITY (TW)

(72) Inventors: Wei-Cheng LIN, Taichung City (TW); Che-Wei HSU, New Taipei City (TW)

(21) Appl. No.: 15/373,381

(22) Filed: Dec. 8, 2016

(30) Foreign Application Priority Data
Dec. 10, 2015 (TW) 104141550

(51) Int. Cl. B60B 21/08; B60B 5/02

(52) U.S. Cl. CPC B60B 21/08; B60B 5/02; B60B 2360/3416; B60B 2310/20; B60B 2360/36; B60B 2900/111; B60B 2900/513; B60Y 2200/13

(57) ABSTRACT

A wheel rim includes a rim body, two firm tracks, and a plurality of hollow anti-thermal unit. The two firm tracks were mounted on two sides of the rim body, and these hollow anti-thermal units are spread in two firm tracks. The hollow anti-thermal unit can reduce transfer rate of the thermal when braking a car.

### RELATED APPLICATIONS

The application claims priority to Taiwan Application Serial Number 104141550, filed on Dec. 10, 2015, which is herein incorporated by reference.

### BACKGROUND

Technical Field

The present disclosure elates to a wheel rim and a method of manufacturing the wheel rim. More particularly, the present disclosure relates to a wheel rim being able to strengthen the wheel structure and lighten the weight and a method for manufacturing the wheel rim.

Description of Related Art

Since carbon fiber composite materials have material characteristics of high strength and low specific density, in recent years, the carbon fiber composite materials have gradually become the materials adopted by many structural parts as well as the driving elements applied in related vehicles. For example, the wheel rims of bicycles are suitable for using the carbon fiber composite material, and this has become the main stream of the market of high-performance bicycles.

However, since the carbon fiber composite materials are min formed by combining fiber materials with macromolecule materials, the structure of the macromolecule materials will be damaged by the high temperature state resulted from the carbon fiber composite materials being rubbed by external forces, such that the overall structure strength is decreased. Accordingly, the structure of the elements using the macromolecule materials cannot bear the loading and impact thereof, and hence the situation of accidental destructions will occur.

Furthermore, the carbon fiber composite materials under the high temperature state are also less resistant to abrasion. When the carbon fiber composite materials used in the wheel rim have been rubbed by braking elements for a long time, the high temperature therebetween will make the wheel rim less resistant to abrasion, and hence the lifetime of the wheel rim will be decreased.

A bicycle fiber wheel rim existing in the current market tries to move the contacting location (braking side) of the braking elements of the bicycle downward to be close to the key part of the overall structure strength. This solution needs to be arranged with a special bicycle brake bosses, which is not conducive for consumers to fix or change in the future. In addition, the aforementioned design merely solves the problem of being lack of strength under high temperatures, but fails to solve the problem of being nonresistant to abrasion, while the weight of the wheel rim is increased as well.

Further, another bicycle fiber wheel rim existing in the current market attaches or uses a basalt fiber on the contacting location (braking side) of the braking elements of the carbon fiber wheel rim. This way merely avoids thermal conduction but fails to overcome the problem of being nonresistant to abrasion and the effects of the abrasion to the macromolecule materials.

### SUMMARY

According to a structure embodiment of the present disclosure, a wheel rim is disposed between two corresponding braking elements. The wheel rim includes a rim body, two firm tracks, and a plurality of hollow anti-thermal units. The rim body adopts a carbon fiber composite material, the two firm tracks are opposite to each other and exposedly mounted on two sides of the rim body, and the two firm tracks, respectively corresponds to the two braking elements; the plurality of hollow anti-thermal units spread in each of the firm tracks.

According to another structure embodiment of the present disclosure, a wheel rim is disposed between two corresponding braking elements. The wheel rim includes a rim body and a plurality of hollow anti-thermal units. The rim body adopts a carbon fiber composite material in one piece. The hollow anti-thermal units are spread in two surfaces corresponding to the two braking elements of the rim body.

According to an embodiment of the present disclosure, another method of manufacturing a wheel rim is proposed, and the method is adapted to manufacturing the aforementioned wheel rim and includes the following steps. A plurality of hollow anti-thermal units are added to a macromolecule material and the hollow anti-thermal units are sufficiently mixed to be spread in the macromolecule material. A carbon fiber material is mixed to become a carbon fiber composite material. The carbon fiber composite material are shaped and hardened on the wheel rim corresponding to the braking elements.

### BRIEF DESCRIPTION OF THE DRAWINGS

The present disclosure can be more fully understood by reading the following detailed description of the embodiment, with reference made to the accompanying drawings as follows:

FIG. 1 illustrates a 3-D sectional view of an embodiment of a wheel rim;

FIG. 2 illustrates a plane sectional view of the wheel rim in FIG. 1;

FIG. 3 illustrates a 3-D sectional view of another embodiment of the wheel rim;

FIG. 4 illustrates a plane sectional view of the wheel rim in FIG. 3; and

FIG. 5 illustrates a flow chart of the method of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

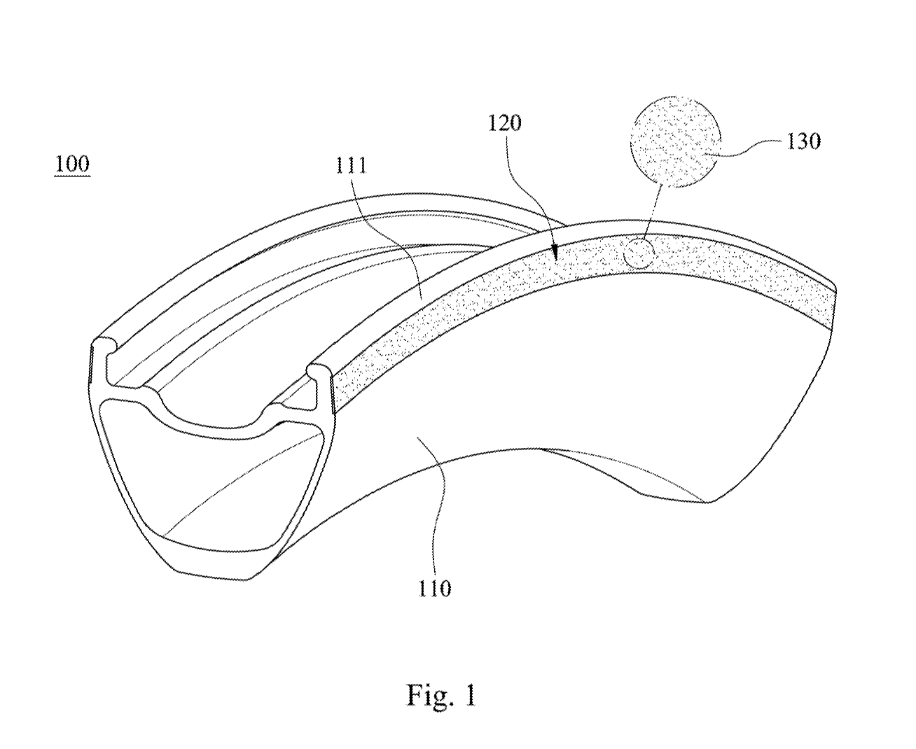

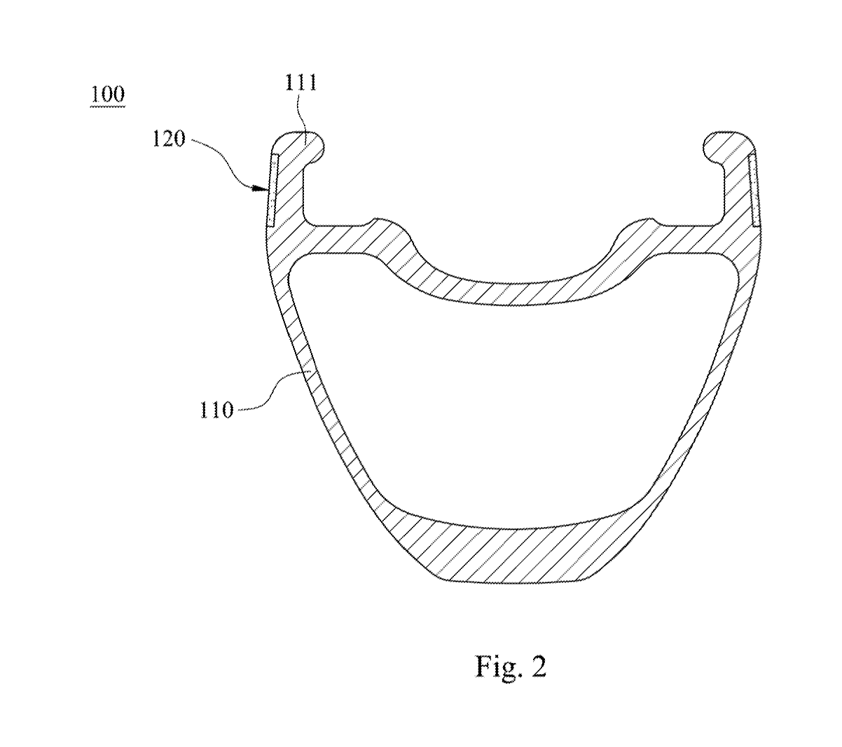

Please refer to both of FIG. 1 and FIG. 2. FIG. 1 illustrates a 3-D sectional view of an embodiment of a wheel rim; FIG. 2 illustrates a plane sectional view of the wheel rim in FIG. 1. According to a structure embodiment of the present disclosure, a wheel rim 100 is proposed to be used on bicycles, where the wheel rim 100 is disposed between two corresponding braking elements (not shown). The wheel rim 100 includes a rim body 110, two firm tracks 120 and a plurality of hollow anti-thermal units 130.

The rim body 110 adopts a carbon fiber composite material mainly including a fiber material with high rigidity and a macromolecule material that enhances the ability of the materials being abrasion-resistant and anti-thermal. The rim body 110 further includes a tire-fixing part 111.

Two firm tracks 120 are opposite to each other and exposedly disposed on two sides of the rim body 110. The two firm tracks 120 respectively correspond to the two braking elements. The tire-fixing part 111 is located closely to the two firm tracks 120.

The hollow anti-thermal units 130 are hollow soda lime borosilicate glass balls, and the hollow anti-thermal units 130 are spread in each of the firm tracks 120. An average particle diameter of the hollow anti-thermal units 130 ranges from 20 μm to 50 μm. By the aforementioned embodiments, the hollow anti-thermal units 130 are used to be mixed and spread in the firm tracks, such that not only the hollow structure of the hollow anti-thermal units 130 can be used, but also the weight of the rim body 110 can be effectively reduced. Moreover, the transmission rate of the thermal energy in the elements can be reduced through the hollow structure feature of the hollow anti-thermal units 130, and hence the goal of preventing the material of the nm body 110 from being damaged by continuous high temperature can be achieved, such that the high temperature will not reach the rim body 110. As a result, the present disclosure can integrate the abrasion-resistant effects with the anti-thermal effects of the hollow anti-thermal units 130.

It should be noted that the hollow anti-thermal units 130 may be hollow ceramic balls.

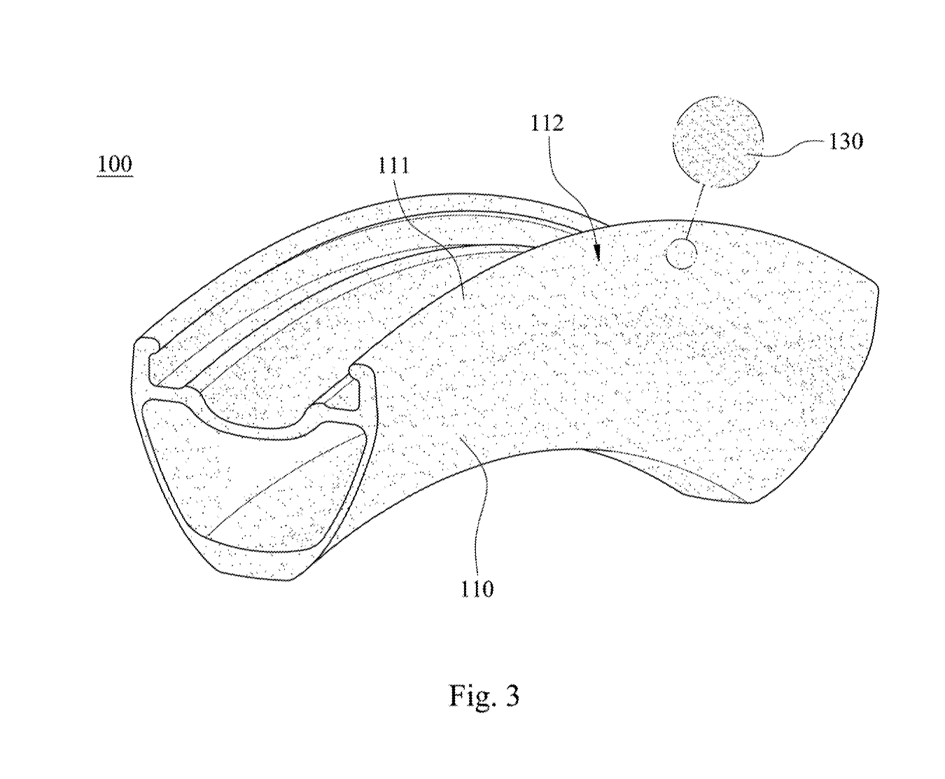

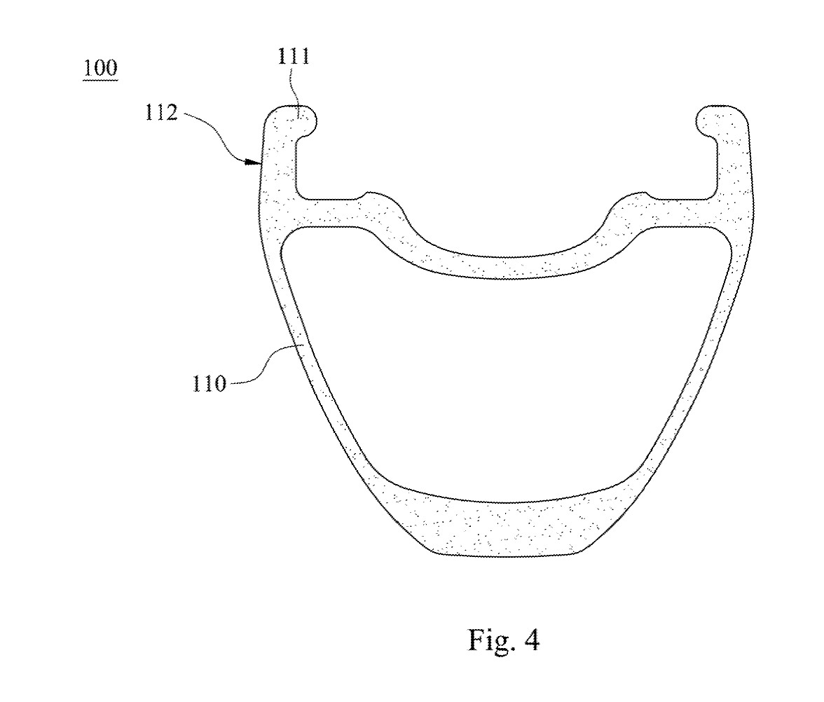

Please further refer to FIG. 3 and FIG. 4. FIG. 3 illustrates a 3-D sectional view of another embodiment of the wheel rim; FIG. 4 illustrates a plane sectional view of the wheel rim in FIG. 3. According to another structure embodiment of the present disclosure, a wheel rim 100 is proposed to be used on bicycles, where the wheel rim 100 is disposed between two corresponding braking elements (not shown). The wheel rim 100 includes a rim body 110 and a plurality of hollow anti-thermal units 130.

The rim body 110 adopting a carbon fiber composite material is formed integrally, and the rim body 110 mainly includes a fiber material with high rigidity and a macromolecule material that enhances the ability of the materials being abrasion-resistant and anti-thermal. The rim body 110 of the bicycles further includes a tire-fixing part 111.

The hollow anti-thermal units 130 are spread in two surfaces 112 corresponding to the two braking elements of the rim body 110, where the surfaces 112 may be all of the surfaces of the rim body 110. By the another embodiment, not only the effects of preventing the high-temperature from reaching the rim body 110 can be achieved, but also the overall weight of the rim body 110 can be lightened by better using the hollow structures of the hollow anti-thermal units 130.

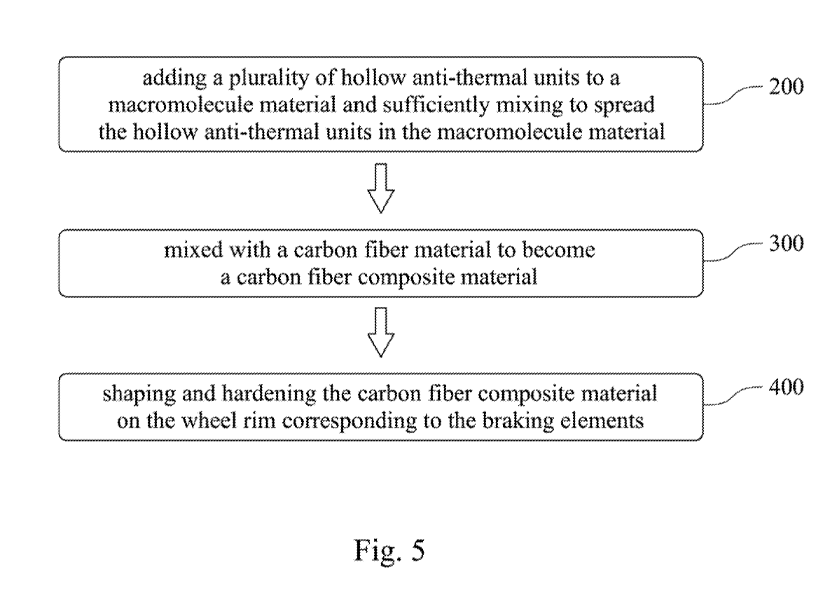

Please refer to FIG. 5, which illustrates a flow chart of the method of the present disclosure. The method in FIG. 5 is the method of manufacturing the wheel rim 100 in FIG. 1 or FIG. 3 and includes the steps as follow. In step 200, a plurality of hollow anti-thermal units are added to a macromolecule material, and the hollow anti-thermal units are sufficiently mixed to spread in the macromolecule material. In step 300, the carbon fiber material is mixed the macromolecule material with the hollow anti-thermal units to become a carbon fiber composite material. In step 400, the carbon fiber composite material is shaped and hardened on the wheel rim corresponding to the braking elements. The materials mixed with the carbon fiber composite materials of step 300 mainly include fiber materials and macromolecule materials.

It can be understood based on the aforementioned embodiments that the wheel rim and the method of manufacturing the wheel rim proposed in the present disclosure may integrate the effect of lightening the wheel rim with the effect of reducing thermal transmission rate to achieve the goals of extending the lifetime of the rim body and lightening the weight.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cove modifications and variations of this disclosure provided they fall within the scope of the following claims.

What is claimed is:

1. A wheel disposed between two corresponding braking elements, comprising:
a rim body adopting a carbon fiber composite material;
two firm tracks opposite to each other and exposedly mounted on two sides of the rim body, wherein the two firm tracks respectively correspond to the two braking elements; and
a plurality of hollow anti-thermal units spread in the two firm tracks.

2. The wheel rim of claim 1, wherein the hollow anti-thermal units are hollow glass balls or hollow ceramic balls.

3. The wheel rim of claim 2, wherein an average particle diameter of the hollow anti-thermal units ranges from 20 μm to 50 μm.

4. The wheel rim of claim 1, wherein the hollow anti-thermal units are hollow soda lime borosilicate glass balls.

5. A wheel rim disposed between two corresponding braking elements, comprising:
a rim body adopting a carbon fiber composite material formed integrally; and
a plurality of hollow anti-thermal units spread in two surfaces of the rim body corresponding to the two braking elements.

6. The wheel rim of claim 5, wherein the hollow anti-thermal units are hollow glass balls or hollow ceramic balls.

7. The wheel rim of claim 5, wherein the hollow anti-thermal units are hollow soda lime borosilicate glass balls.

8. The wheel rim of claim 7, wherein an average particle diameter of the hollow anti-thermal units ranges from 20 μm to 50 μm.

9. A method of manufacturing the wheel rim as in any one of claim 1, comprising:
adding the plurality of hollow anti-thermal units to a macromolecule material and sufficiently mixing to spread the hollow anti-thermal units in the macromolecule material;
mixing with a carbon fiber material to become a carbon fiber composite material; and
shaping and hardening the carbon fiber composite material on the wheel rim corresponding to the braking elements.

10. The method of manufacturing the wheel rim of claim 9, wherein the hollow anti-thermal units are hollow soda lime borosilicate glass balls, and an average particle diameter of the hollow anti-thermal units ranges from 20 μm to 50 μm.
